(19) United States
(12) Patent Application Publication
(10) Pub. No.: US 2026/0361455 A1
(43) Pub. Date: Nov. 12, 2026

(54) SYSTEMS AND METHODS OF BACKSCATTER COMMUNICATION WITH REDUCED SYNCHRONIZATION REQUIREMENTS

(71) Applicant: HaiLa Technologies Inc., Montreal (CA)

(72) Inventors: Juan Miguel David Becerra, Montreal (CA); Vytas Kezys, Ancaster (CA); Matheus Ferronato Lesmes, Abu Dhabi (AE); Jose Alejandro Castro Ortegon, Montreal (CA); Nelson Costa, Grimsby (CA)

(21) Appl. No.: 19/673,794

(22) Filed: May 11, 2026

Related U.S. Application Data
(60) Provisional application No. 63/803,816, filed on May 11, 2025.

(51) Int. Cl. H04L 1/00

(52) U.S. Cl. CPC H04L 1/0042

(57) ABSTRACT

Systems and methods of backscatter communication are provided. The method includes transmitting, by a transmitter, a signal including a template frame, the template frame including a pre-defined template payload; receiving, at a backscattering device from the transmitter, the signal including the template frame; generating, at the backscattering device, a repetition coded message based on a target payload by repeating each bit of the target payload at least three times sequentially; encoding, at the backscattering device, the repetition coded message over the template frame based on a synchronization with the pre-defined template payload to generate a modified data payload; transmitting, at the backscattering device, a backscattered signal including a backscattered frame that includes the modified data payload; receiving, at a receiving device, the backscattered signal and providing the received signal to a processing device; and decoding, at the processing device, the signal from the receiving device to recover the target payload.

### CROSS-REFERENCE TO RELATED APPLICATION

This application claims the benefit of United States Provisional Patent Application No. 63/803,816 filed May 11, 2025, and the entire content of United States Provisional Patent Application No. 63/803,816 is incorporated by reference herein.

### FIELD

The presently disclosed systems and methods generally related to radio frequency (RF)-based backscatter communications systems, and specifically, to methods of encoding and decoding data in a backscatter communications system with reduced synchronization requirements.

### INTRODUCTION

Backscatter communication has attracted interest for applications such as implantable sensors, wearables, and smart home sensing because of its ability to offer low power connectivity to such sensors.

Hardware used in such applications may be constrained in terms of cost and power. Implantable sensors, for example, may be required to operate with minimal maintenance for years. Smart home monitoring applications may additionally benefit from sensors and actuators that can last for several years. Backscatter communication can satisfy the connectivity requirements while consuming such low power as to be energized by harvesting energy, or with batteries that could last several years.

In the interest of minimizing power consumption and cost, transceivers used in backscatter communications are generally low complexity devices. Using fewer hardware components and simpler processing may result in lower cost and power consumption.

### SUMMARY

In a first broad aspect, there is provided a method for backscatter communication. The method includes transmitting, by a transmitter, a signal including a template frame, the template frame including a pre-defined template payload; receiving, at a backscattering device from the transmitter, the signal including the template frame; generating, at the backscattering device, a repetition coded message based on a target payload by repeating each bit of the target payload at least three times sequentially; encoding, at the backscattering device, the repetition coded message over the template frame based on a synchronization with the pre-defined template payload to generate a modified data payload; transmitting, at the backscattering device, a backscattered signal including a backscattered frame, the backscattered frame including the modified data payload; receiving, at a receiving device, the backscattered signal and providing the received signal to a processing device; and decoding, at the processing device, the signal from the receiving device to recover the target payload.

In some embodiments, encoding the repetition coded message over the template frame may include performing a codeword translation on each symbol of the pre-defined template payload based on a corresponding bit of the repetition coded message.

In some embodiments, decoding the signal from the receiving device may include: applying, at the processing device, a reverse codeword translation corresponding to the codeword translation performed at the backscattering device and based on the pre-defined template payload to recover the modified data payload.

In some embodiments, decoding the signal from the receiving device may further include reversing, at the processing device, at least one processing operation applied to the backscattered signal by the receiving device.

In some embodiments, reversing the at least one processing operation applied to the backscattered signal by the receiving device may include: scrambling, at the processing device, a frame of the signal from the receiving device using an all-zero initial seed, thereby generating an intermediate data payload; and differentially encoding, at the processing device, the intermediate data payload, thereby generating an output payload.

In some embodiments, decoding the signal from the receiving device may include removing, at the processing device, at least one repeated data bit from the output payload to recover the target payload.

In some embodiments, removing the at least one repeated data bit may include looping, at the processing device, through the output payload to remove a pre-determined quantity of data repetitions from the output payload.

In some embodiments, removing the at least one repeated data bit may include: applying, at the processing device, one or more convolution kernels to the output payload to produce one or more correlation outputs, each convolution kernel having a different kernel size; determining, at the processing device, a repetition factor based on a peak frequency associated with each of the one or more correlation outputs.

In another broad aspect there is provided a system for backscatter communication. The system includes a transmitter, a backscattering device, a receiving device, and a processing device. The transmitter is configured to transmit a signal including a template frame, the template frame including a pre-defined template payload. The backscattering device is configured to: receive, from the transmitter, the signal including the template frame; generate a repetition coded message based on a target payload by repeating each bit of the target payload at least three times sequentially; encode the repetition coded message over the template frame based on a synchronization with the pre-defined template payload to generate a modified data payload; and transmit a backscattered signal including a backscattered frame, the backscattered frame including the modified data payload. The receiving device is configured to: receive the backscattered signal and provide the received signal to a processing device. The processing device is configured to: decode the signal from the receiving device to recover the target payload.

In some embodiments, the backscattering device is further configured to encode the repetition coded message over the template frame by performing a codeword translation on each symbol of the pre-defined template payload based on a corresponding bit of the repetition coded message.

In some embodiments, the processing device is further configured to decode the signal from the receiving device by applying a reverse codeword translation corresponding to the codeword translation performed at the backscattering device and based on the pre-defined template payload to recover the modified data payload.

In some embodiments, the processing device is further configured to decode the signal from the receiving device by reversing, at the processing device, at least one processing operation applied to the backscattered signal by the receiving device.

In some embodiments, the processing device is further configured to reverse the at least one processing operation applied to the backscattered signal by the receiving device by: scrambling a frame of the signal from the receiving device using an all-zero initial seed, thereby generating an intermediate data payload; and differentially encoding the intermediate data payload, thereby generating an output payload.

In some embodiments, the processing device is further configured to decode the signal from the receiving device by removing at least one repeated data bit from the output payload.

In some embodiments, the processing device is configured to remove the at least one repeated data bit from the output payload by looping through the output payload to remove a pre-determined quantity of data repetitions from the output payload.

In some embodiments, the processing device is configured to remove the at least one repeated data bit from the output payload by: applying one or more convolution kernels to the output payload to produce one or more correlation outputs, each convolution kernel having a different kernel size; and determining a repetition factor based on a peak frequency associated with each of the one or more correlation outputs.

In another broad aspect there is provided a device for backscatter communication. The device is configured to: receive a signal including a template frame, wherein the template frame includes a pre-defined template payload; generate a repetition coded message based on a target payload by repeating each bit of the target payload at least three times sequentially; encode the repetition coded message over the template frame based on a synchronization with the pre-defined template payload to generate a modified data payload; and transmit a backscattered signal including a backscattered frame, the backscattered frame including the modified data payload, and the modified data payload being decodable to recover the target payload after the backscattered signal is received.

In some embodiments, the device is further configured to encode the repetition coded message over the template frame by performing a codeword translation on each symbol of the pre-defined template payload based on a corresponding bit of the repetition coded message.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a schematic diagram of an example system for backscatter communication in accordance with some embodiments;

FIG. 2 is a block diagram showing an example signal flow between components of the system of FIG. 1;

FIG. 3 is a flowchart of an example method for backscatter communication with reduced synchronization requirements;

FIG. 4 is a diagram of an example repetition encoding using codeword translation; and

FIG. 5 is a diagram of an example decoding of a backscattered signal using the method of FIG. 3.

Further aspects and features of the example embodiments described herein will appear from the following description taken together with the accompanying drawings.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

In the description and drawings herein, reference may be made to a Cartesian co-ordinate system in which the vertical direction, or z-axis, extends in an up and down orientation from bottom to top. The x-axis extends in a first horizontal or width dimension perpendicular to the z-axis, and the y-axis extends cross-wise horizontally relative to the x-axis in a second horizontal or length dimension.

The terms "an embodiment," "embodiment," "embodiments," "the embodiment," "the embodiments," "one or more embodiments," "some embodiments," and "one embodiment" mean "one or more (but not all) embodiments of the present invention(s)," unless expressly specified otherwise.

The terms "including," "comprising" and variations thereof mean "including but not limited to," unless expressly specified otherwise. A listing of items does not imply that any or all of the items are mutually exclusive, unless expressly specified otherwise. The terms "a," "an" and "the" mean "one or more," unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, and “fastened” distinguish the manner in which two or more parts are joined together.

Embodiments herein provide a system and method of backscattered communication that is compliant with existing communications protocols, such as Wi-Fi 802.11g/n, Bluetooth, and ZigBee. To this end, it will be noted that, while for simplicity and ease of description, embodiments herein reference communication via 802.11b compliant Wi-Fi frames, the described embodiments are not so limited such that the disclosed backscatter communication systems may operate with other similar communication standards.

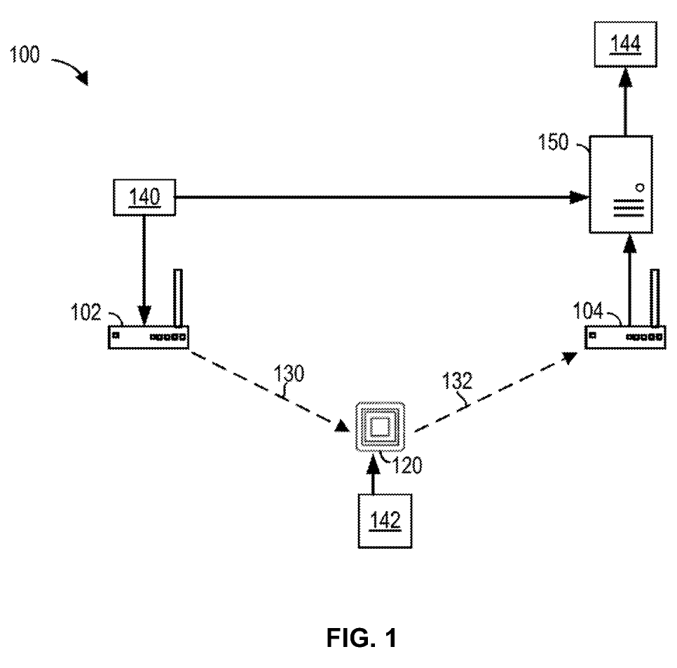

Reference is first made to FIG. 1, which shows an example bistatic backscatter communication system 100 in accordance with one or more embodiments. System 100 includes a transmitter 102, a receiving device 104, a backscattering device 120, and a processing device 150.

System 100 may be specifically configured for bistatic backscatter communication, in which the transmitting device and the receiving device are located at different positions. In some embodiments, one or more of the transmitting and receiving units may in-fact contain both transmitting and receiving functionalities. Transmitter 102, receiving device 104, backscattering device 120, and processing device 150 may include any suitable combination of components including a processor and a memory device to implement the methods described herein.

The transmitter 102 may be configured for transmitting excitation signals 130. Signals 130 can be radio-frequency (RF) signals having a pre-defined carrier frequency. Signals 130 may be modulated in accordance with modulation and encoding schemes to encode data. For example, signals 130 can be modulated to carry 802.11 compliant Wi-Fi frames. The excitation signals 130 may be modulated and encoded in accordance with protocols such as IEEE 802.11, Bluetooth, Zigbee, Z-Wave, or any other suitable RF communication standard or protocol. Transmitting device 102 may contain the requisite hardware and software for transmitting signals in accordance with the aforementioned protocols.

Transmitter 102 may include any device configured to communicate via an RF radio. Transmitter 102 can include, for example, a mobile phone equipped with a standard Wi-Fi radio, in which case excitation signals 130 may be, for example, IEEE 802.11 compliant WLAN data frames. As another example, transmitter 102 can be a laptop computer equipped with a Bluetooth radio, in which case transmitted signals 130 may be, for example, Bluetooth Low Energy data frames.

Transmitter 102 may apply a number of auxiliary operations to encode and modulate an input message in signal 130. The auxiliary operations can be defined in accordance with the communication protocol used. For example, for IEEE 802.11 compliant Wi-Fi frames, the transmitter can apply a scrambler to the input message to enhance the randomness of the transmitted bits. As another example, the transmitter 102 can apply a differential encoder to the message, which may enhance bit synchronization.

Transmitter 102 can include, for example, a mobile phone with a standard Wi-Fi radio. In other cases, transmitter 102 may be any other device configured to communicate via a Wi-Fi radio. In turn, receiver 104 may be a device configured to receive the Wi-Fi frames. In some cases, the receiver 104 can comprise, for example, a Wi-Fi access point, or any other suitable reception device.

The excitation signal can carry a pre-defined template payload. For example, the excitation signal 130 can be modulated to carry a frame defined in accordance with a communication protocol. For example, the frame can be a 802.11b compliant Wi-Fi frame that includes headers, preamble, body, and other parts of a Wi-Fi frame. The frame can be a template frame, that is to say, the body of the template frame can include a pre-defined template payload. The pre-defined template payload may be a message that is known to both the transmitter 102 and receiving device 104.

Receiving device 104 may be configured to receive signals that are in adherence with a defined modulation and encoding scheme. For example, receiving device 104 may be capable of decoding and demodulating frames sent in accordance with IEEE 802.11, Bluetooth, Zigbee, Z-Wave, or any other RF communication standard or protocol as may be used by transmitter 102. Receiving device 102 may contain the requisite hardware and software for receiving signals transmitted in accordance with the aforementioned protocols as may be required. For example, receiving device 104 can be a Wi-Fi access point configured to receive and decode RF signals containing Wi-Fi compliant frames.

Backscattering device 120 may operate to receive the excitation signals 130 being transmitted by transmitter 102. In particular, device 120 is configured to alter the excitation signals 130 by encoding a target payload 142 over the pre-defined template payload 140 contained in the signal 130, and then transmit a backscattered signal 132 containing a modified data payload. For example, device 120 may receive one or more Wi-Fi frames in excitation signal 130 containing a payload transmitted by the transmitting device 102. Device 120 may then be operable to manipulate the payload data in the excitation signal 130 to encode a target payload 142 onto the received frames to create a backscattered frame. Device 120 may then backscatter the backscattered frame.

The target payload 142, which is encoded by the backscattering device 102, can vary based on the application of system 100. For instance, in at least one example application, the target payload can comprise sensor data generated by a sensor system coupled to the backscattering device. In this manner, and as stated in the background, backscattering device 120 can facilitate implementation of ultra low-power sensor networks.

Backscattering device 120 may be configured to operate on the channel or frequency on which the transmitting device 102 operates and on which the signal 130 is transmitted. However, in some embodiments, the backscattering device may be operable to receive signals on different channels or frequencies.

Backscattering device 120 may apply various different methods to manipulate the pre-defined template payload carried in the incident excitation signal 130 to generate the modified data payload carried in the backscattered signal 132. For example, codeword translation may be performed on the symbols of the pre-defined template payload contained in the template frame in the signal 130. The codeword translation can be accomplished by modifying, for example, one of the amplitude, phase or frequency of one or more symbols of the incident excitation signal 130.

For example, as described in United States Patent No. 10,338,205 to Zhang et al, filed August 14, 2017 and issued July 2, 2019; and United States Publication No. 2019/0274144 to Zhang et al, filed April 25, 2019, both of which are hereby incorporated in their entirety by reference, the codeword translation may involve, for example, XOR’ing the data symbols in an originally transmitted payload (i.e., pre-defined template payload 140 in signal 130), with data from device 120, to generate the backscattered signal 132 containing a modified data payload. The data symbols can also be, for example, phase shifted to encode the target payload on the pre-defined template.

As another example, for modulation schemes using quadrature amplitude modulation (QAM) such as 802.11a/g/n, an amplitude, phase, or frequency of a symbol can be modified to shift one codeword into another. A ‘0’ bit in the target payload can correspond to a particular codeword translation (such as an amplitude, phase, or frequency shift) and a ‘1’ bit can correspond to a different translation. Each symbol of the original payload can be translated in accordance with the codeword translation for the corresponding bit of the target payload.

In some embodiments, backscattering device 120 may further be configured to frequency shift the backscattered signal 132 onto a different frequency or channel. For example, device 120 may generate a frequency-shifted backscattered signal 132 based on the original signal 130, received on the first channel, and may transmit the backscattered signal 132 on a second channel.

Backscattering device 120 can include various passive circuitry components that operate on the incident signal 130 in order to encode (i.e., manipulate) signal 130 with the tag’s own data. Various architectures and configurations for the passive circuitry for backscattering tags are known in the art.

The data encoded by the backscattering device 120, can vary based on the application of system 100. For instance, in at least one example application, the data can comprise sensor data generated by a sensor system coupled to the device 120. In this manner, and as stated in the background, backscattering device 120 can facilitate implementation of ultra low-power sensor networks.

As described, receiving device 104 may be able to receive signals on various different channels. Receiving device 104 may then receive backscattered signal 132 on the channel on which it is transmitted. Receiving device 104 may extract the modified data payload by demodulating and decoding the backscattered signal 132.

For example, receiving device 104 may be a Wi-Fi access point and may contain a Wi-Fi radio configured to read Wi-Fi frames contained in received signals. The receiving device 104 may demodulate the signal, process and decode the preamble and header information contained in the frame, and extract the payload contained in the frame.

In some embodiments, the receiving device 104 may apply various operations to reverse operations applied at the transmitting device. In some embodiments, the receiving device 104 may apply differential decoding to the demodulated signal to reverse the differential encoding applied at the transmitter. In some embodiments, the receiving device 104 may apply descrambling to the demodulated signal to reverse the scrambling applied at the transmitter. The receiving device 104 can perform further processing operations on the signal and its decoded contents, such as verifying integrity of the extracted frame using a frame check sequence.

The receiving device 104 may demodulate and decode the backscattered signal 132 to obtain a received frame. The receiver 104 can then transfer the received frame to a processing device 150 to recover the original target payload 142 encoded at the backscattering device 120.

Processing device 150 may be configured to process the received frame to extract the target payload. Processing device 150 may be a computing device configured to implement various methods and algorithms for extracting the target payload from the backscattered frame. For example, processing device 150 can be a personal computer, a laptop, a tablet, a mobile phone, a server, a system-on-a-chip computer, and any other similar type of device. In some embodiments, processing device 150 can be a part of receiving device 104.

Processing device 150 may be configured to reverse the codeword translation on the modified data payload to extract the original target payload. For example, as described in United States Patent 10,338,205 to Zhang et al and United States Publication No. 2019/0274144 to Zhang et al, where the codeword translation involves an XOR operation applied to the originally transmitted frame at the backscattering device 102, another XOR operation can be used to reverse the original XOR. An XOR may be applied on the symbols in the modified data payload in the backscattered signal 132 with the bits in the original data payload of the original excitation signal 130 to recover the data bits associated with the target payload.

The excitation signal 130 can contain a pre-determined template known to both the transmitting device 102 and the receiving device 104. By transmitting a signal in accordance with a pre-determined template that is known to both parties, the need for receiver 104 to directly receive the original signal 130 to decode the contents of backscattered signal 132 may be obviated. For example, the transmitting device 102 may transmit a packet having an all “0” payload or an all “1” payload (e.g., “0000000”). The backscattering device, when backscattering the packet, 120 may encode its own backscattering data only to payload by performing an XOR on certain bits of the payload. The receiving device can then, upon receiving the packet, decode the backscattering data by, for example, XOR the backscattered payload with the known pre-determined template data payload, which is already known to the receiving device without receiving excitation signal 130 directly, to recover the data of the backscattering device.

As another example, for codeword translations involving QAM symbols, the original payload containing the pre-determined template can be compared to the received payload to determine the target payload. For example, the original payload can be compared to the received payload. A difference in phase, frequency, phase, or a combination thereof can be determined for each symbol in the received payload. Based on the observed difference, the codeword translation that was applied to each symbol of the original payload can be determined. The bit corresponding to each applied codeword translation can then be determined, thereby allowing the regeneration of the target payload that was encoded onto the backscattered frame via codeword translation.

Time synchronization between the transmitter 102 and the backscattering device 120 may be required to perform the codeword translation. Misalignment between the backscattering device encoding the target payload data on the frame and the original symbols in the frame may change the barker code of the communication, which may impact the signal-to-interference ratio (SNR) of the signal. These synchronization errors may produce higher bit error rates. For example, Dunna et al. (2021) showed that synchronization errors greater than 150ns can lead to 7dB or more bit error rate degradation. This may limit the effective operating distance of the backscattering device.

Additionally, synchronization is required so that the backscattering device can perform codeword translation only onto payload portion of a frame. Other portions of the frame, such as preambles, headers, and frame check sequences, may need to be preserved to ensure that the receiving device 104 can properly receive the frame in the backscattered signal 132.

Backscattering device 120 may implement a simple synchronization method that can be operated on low complexity hardware and can consume minimal energy. For example, in some embodiment, the transmitter 102 may transmit a known pattern or sequence to signal that the backscatter should begin. The backscattering device 120 may detect the pattern, and begin encoding at a set time period thereafter.

It will be appreciated that, while more complex means of synchronization may exist that can result in lower timing error, and as a result, lower bit error rates, such solutions may contribute additional costs on the backscattering device, such as requiring greater hardware costs and/or higher power consumption. The presently disclosed systems and methods may reduce the amount of synchronization required to achieve acceptable bit error rates. For example, for the same level of synchronization (the same amount of timing error), the presently disclosed systems and methods may achieve better bit error rates.

Backscattering device 120 may reduce the bit error rate by performing repetition coding of the target payload data to facilitate proper decoding of the backscattered frame, in which each bit to be encoded is repeated multiple times.

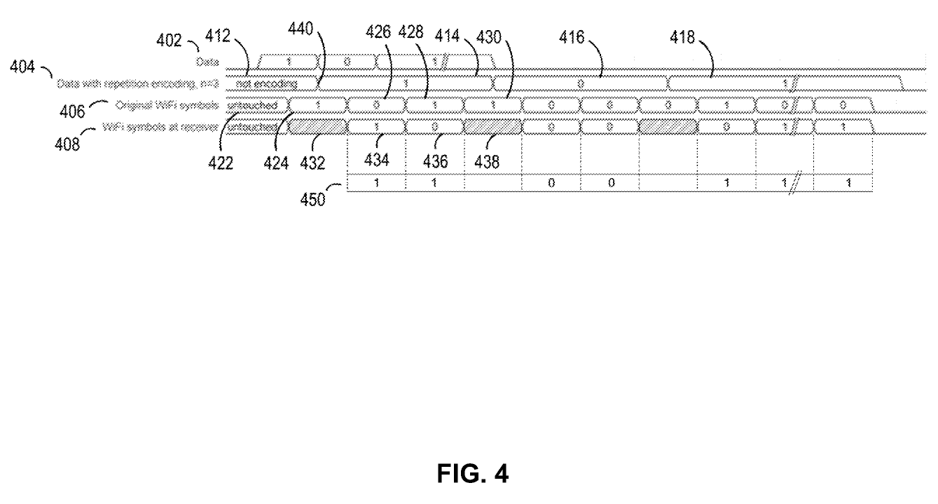

To demonstrate this, reference is made to FIG. 4, which shows the bits of an example target payload data 402, the target payload data with repetition 404, the symbols of an example original Wi-Fi frame 406 for encoding the target payload data onto, and the symbols of the resulting received frame 408 at the receiving device.

As shown, example target payload data 402 may comprise a sequence of bits of the form [1, 0, 1…1]. Each bit in the sequence may be repeated to generate the repetition data 404. Any number of repetitions can be used, but preferably, 3 or more repetitions may be used. In the example shown in FIG. 4, three repetitions are used, and the sequence then becomes [1, 1, 1, 0, 0, 0, 1, …,1].

The data 404 with repetitions can then be encoded onto the original Wi-Fi frame 406 received from the transmitter 102. The data 404 may be encoded onto a payload portion of the frame 406, i.e., so that surrounding data, such as headers and preambles, are unaffected.

In the example shown, original Wi-Fi frame 406 may be modulated using a codebook containing two codewords, represented as ‘1’ and ‘0’. For example, the frame 406 may be an IEEE 802.11b compliant frame that uses a first codeword and a second codeword, where the second codeword is phase offset by 180 degrees relative to the first codeword, to represent the ‘1’ and ‘0’.

The encoding of the data 404 onto the data of frame 406 can then be performed using an XOR block. For example, in the example where two codewords differing by 180 degrees are used, the XOR block can be implemented, for example, using an inverter or a phase shifter circuit. Encoding a ‘0’ on a symbol can entail adding a phase shift of 0 degrees on the symbol. Encoding a ‘1’ on a symbol can entail adding a phase shift of 180 degrees on the symbol.

There may be imperfect synchronization between the backscattering device and the transmitter. As shown, the backscattering device only begins encoding at time 440. Prior to that, there is no modification or codeword translation applied to the symbols of the frame (e.g., 412). As such, only symbol 424 of frame 406 is affected by the codeword translation. Symbol 422 and symbols prior (which may, for example, contain header information) remain unchanged.

As shown, the first ‘1’ bit of the target payload data sequence 402 is repeated three times in the repetition data 404. The extended first ‘1’ bit 414 overlaps with symbols 424, 426, 528, and 430. However, there is only partial overlap between bit 414 and symbols 424 and 430 due to lack of synchronization. As such, symbols 432 and 438, which will contain undesirable data due to lack of synchronization, can be disregarded.

The XOR operation, or more generally, the codeword translation, applied to the symbols of the received frame 408, can be reversed at the receiver. For example, the receiver may transmit the frame to an XOR block. The XOR block can be implemented in software (e.g., using processing device 150 of FIG. 1) or in hardware (e.g., using a circuit to apply an inversion or a phase shift to a signal).

The codeword translation can be reversed using the original transmitted frame. The originally transmitted frame may contain a pre-defined template that is known by the transmitter and the decoding device (e.g., the receiver and/or the processing device). For example, an XOR can be performed on the bits of the received frame payload and the pre-defined template frame payload, which would return the target payload that was encoded onto the received frame.

As shown, by applying an XOR between the original frame data 406 and the received data 408, resulting data 450 is produced, which is a repetition coded message with n-1 repetitions, where n is the original number of repetitions used. As shown, the repetitions can then be removed to recover the original data 402.

In some embodiments, a scrambler and differential encoder may be applied at the transmitter 102 to signal 130, and a descrambler and differential decoder may be applied to the receiver 104 to signal 132. However, as signal 130 differs from signal 132, the descrambling and differential decoding at receiver 104 will not reverse the scrambling and differential encoding performed at transmitter 102. Instead, the resulting recovered data will be shuffled.

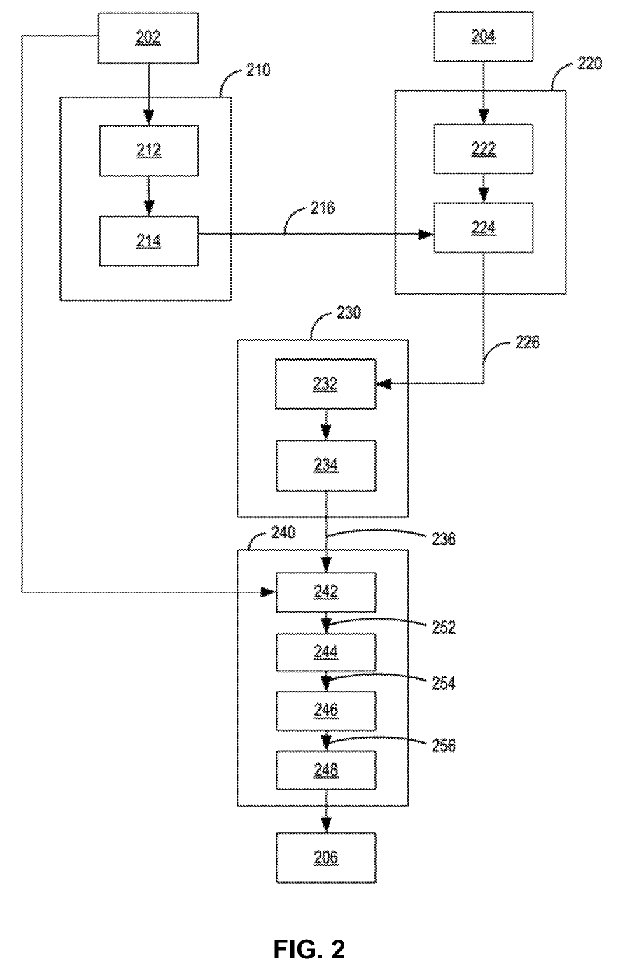

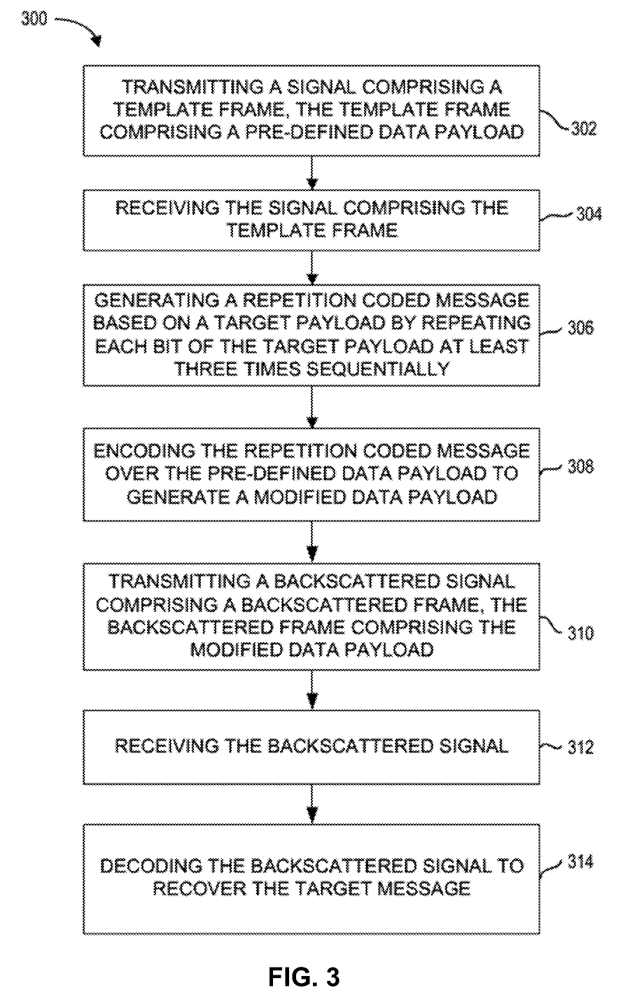

To address the above problem, reference is next made to FIG. 3, which shows a method 300 for backscatter communication with reduced synchronization requirements. Method 300 may be implemented using system 100 of FIG. 1. Reference is additionally made to FIG. 2, which shows a block diagram 200 of various processing steps occurring during the operation of system 100 of FIG. 1 in accordance with an embodiment of method 300. Transmitter 210, backscattering device 220, receiving device 230, and processing device 240 are shown in diagram 200. Transmitter 210 may be the transmitter 102 of FIG. 1. Backscattering device 220 may be the backscattering device 120 of FIG. 1. Receiving device 230 may be the receiving device 104 of FIG. 1. Processing device 240 may be the processing device 150 of FIG. 1.

Method 300 begins at 302, with transmitting, by a transmitter, a signal comprising a template frame, the template frame comprising a pre-defined template payload.

For example, transmitter 210 may be configured to modulate and encode a transmitter payload 202 into a Wi-Fi frame. Transmitter 210 may transmit the frame in an output transmission 216.

In some embodiments, the transmitter payload 202 may be a pre-determined template payload. The pre-determined template payload may be known to the receiver. For example, the pre-determined template payload can be a sequence of bits such as ‘10101010’.

In generating the output signal 216, transmitter 210 may process the transmitter payload 202 using a scrambler 212 and differential encoder 214. Scrambler 212 may be configured to randomize input sequences to, among other purposes, improve spectral quality and facilitate clock recovery at a receiver. 212 may use an initial seed in producing a randomized output. Scrambler 212 can be a self-synchronizing scrambler. Scrambler 212 may be implemented in hardware. For example, scrambler 212 can use a linear feedback shift register initialized with a seed value to XOR each outgoing bit in an input sequence to produce a randomized output sequence.

Differential encoder 214 may be configured to encode an input sequence into an output sequence such that each output bit changes relative to the previous output bit. For example, the differential encoder can be implemented using a logical circuit that XOR’s each input bit with the previously produced output bit to produce the next output bit.

The method proceeds to 304 with receiving, at a backscattering device from the transmitter, the signal comprising the template frame. For example, backscattering device 220 may receive signal 216 transmitted from transmitter 210.

The method proceeds to 306 with generating, at the backscattering device, a repetition coded message based on a target payload by repeating each bit of the target payload at least three times sequentially.

The target payload data 204 may be a payload that is desired to be transmitted from the backscattering device to the receiver. For example, payload data 204 may be sensor data from a sensor connected to the backscattering device 204.

Backscattering device 220 may include a repetition block 222 to generate bit repetitions for each bit of the target payload data 204. For example, payload data 204 can be fed into repetition block 222 and a repetition coded output message can be produced, where each bit of the payload data is repeated n times.

The method proceeds to 308 with encoding, at the backscattering device, the repetition coded message over the template frame to generate a modified data payload. For example, backscattering device 220 may encode the target payload data 204 onto the received frame in output signal 216.

In some embodiments, the encoding, at the backscattering device, the repetition coded message over the pre-defined template payload comprises performing a codeword translation on each symbol of the pre-defined template payload based on a corresponding bit of the repetition coded message. For example, backscattering device 220 may contain a codeword translation block 224 for performing codeword translation to encode the target payload 204 onto the transmitter payload 202 in signal 216.

In some embodiments, the codeword translation block may be an XOR block. For example, the WiFi frame in signal 216 can be modulated using two codewords that differ by an 180 degree phase shift, such as in IEEE 802.11b 1Mbps transmission mode codebooks. The XOR block can be implemented, for example, using a circuit configured to invert or apply a phase shift to a symbol in the sequence based on whether an input is a 1 or 0.

The method proceeds to 310 with transmitting, at the backscattering device, a backscattered signal comprising a backscattered frame, the backscattered frame comprising the modified data payload.

For example, backscattering device 210 may backscatter the received signal 216 to transmit a modified signal 226 that includes the original signal but with the target payload 204 encoded onto the signal using the codeword translation block 224.

The method proceeds to 312 with receiving, at a receiving device, the backscattered signal. Receiver 230 may receive the backscattered signal 226 from backscattering device 220.

The receiving device may apply differential decoding and descrambling to the backscattered signal as a part of the receive chain. For example, receiving device 230 may contain a differential decoder block 232 and a descrambler block 234.

Differential decoder block 232 may be configured to reverse the effects of the differential encoding applied at block 214. Differential decoder block 232 may compare a current symbol with a previous symbol to determine an output bit. Differential decoder block 232 may successfully recover the scrambled data that was input to differential encoder 214 for portions of the original transmitted signal 216 that were not modified by backscattering device 220. However, at this stage, the differential decoder block 232 may not successfully reverse the effects of the differential encoding applied at block 214 for portions of the original transmitted signal 216 that were modified by backscattering device 220 (to encode target payload data 204).

Descrambler block 234 may be configured to reverse the effects of the scrambling applied at block 212. For example, a descrambler circuit may be configured to XOR a current input bit with a previous input bit to generate a next output bit. Descrambler block 234 may successfully recover the transmitter payload 202 that was input to scrambler 212 for portions of the original transmitted signal 216 that were not modified by backscattering device 220. However, at this stage, the descrambler block 234 may not successfully reverse the effects of the scrambling applied at block 212 for portions of the original transmitted signal 216 that were modified by backscattering device 220 (to encode target payload data 204).

The method proceeds to 314 with decoding, at a processing device, the backscattered signal to recover the target payload. In some embodiments, the method may not involve a processing device. For example, the functionality provided by the processing device may be provided by the receiving device 230.

The receiving device 230 may produce an output digital signal 236 for processing at the processing device 240. Processing device 240 may decode the output signal 236 to extract the original target payload 204.

In some embodiments, the decoding, at the processing device, the backscattered signal includes applying, at the processing device, a reverse codeword translation on each symbol of the modified data payload based on a comparison of the symbol with a corresponding symbol in the pre-defined template payload.

Processing device 240 may contain a codeword translation block 242 for reversing the codeword translation performed at the backscattering device 220 at block 224. Codeword translation block 242 can use the template frame 202, which may be a known pre-defined template, to reverse the codeword translation. For example, codeword translation block 242 can be a software algorithm configured to perform an XOR on the codewords of the output digital signal 236 using the pre-determined template payload 202.

However, as described, after the backscattering device 220 encodes the target payload 204 onto the frame data, the differential decoding and descrambling operations performed at the receiver result in data that is shuffled relative to the original transmitted data. As such, when the codeword translation is applied at block 242, the data 252 is a shuffled version of the target payload data 204. In other words, perfect recovery of the target payload data 204 cannot be achieved at this stage.

Additionally, receiver 230 may be a consumer hardware device for receiving communications in accordance with Bluetooth, Wi-Fi, Zigbee, or any other similar protocol, containing internal processing blocks that cannot be disabled without substantial effort or modification. For example, in typical WiFi receiver devices, descrambling and differential decoding occurs at hardware level on reception of the signal and cannot be bypassed. As such, it is often not possible to avoid these processing functions when using low-complexity commodity Wi-Fi infrastructure.

The processing unit 230 may perform further processing on the received data in order to remove the processing done by receiver 230 on the backscattered signal 226 in order to recover target payload data 204. For example, the processing unit 230 may need to un-shuffle the shuffled data 252. The processor may, for example, perform further scrambling and/or differential encoding operations to reverse the processing performed by receiver 230 at blocks 232 and 234.

In some embodiments, the decoding, at the processing device, the backscattered signal further comprises scrambling, at the processing device, a received frame of the backscattered signal using an all-zero initial seed, thereby generating an intermediate data payload and differentially encoding, at the processing device, the intermediate data payload, thereby generating an output payload.

For example, processing unit 240 may include an output scrambler 244, which may be configured to scramble the shuffled data 252 using an initial seed of all ‘0’s. The result will be scrambled data 254. Processing unit 240 may further include an output differential encoder 246, which may be configured to perform differential encoding on the scrambled data 254. The result will be the repetition-coded target output payload 256.

In some embodiments, the output scrambler 244 and output differential encoder 248 may be implemented in software. For example, the shuffled data can be represented in a computer data structure as a sequence of binary bits, and a software algorithm can be configured to perform the necessary logical operations to implement the scrambler and differential encoder.

In some embodiments, the decoding, at the processing device, the backscattered signal further comprises removing, at the processing device, at least one repeated data bit from the output payload. For example, the processing device may include a repetition removal block 248 for removing the repetitions in the repetition-coded target output payload 256.

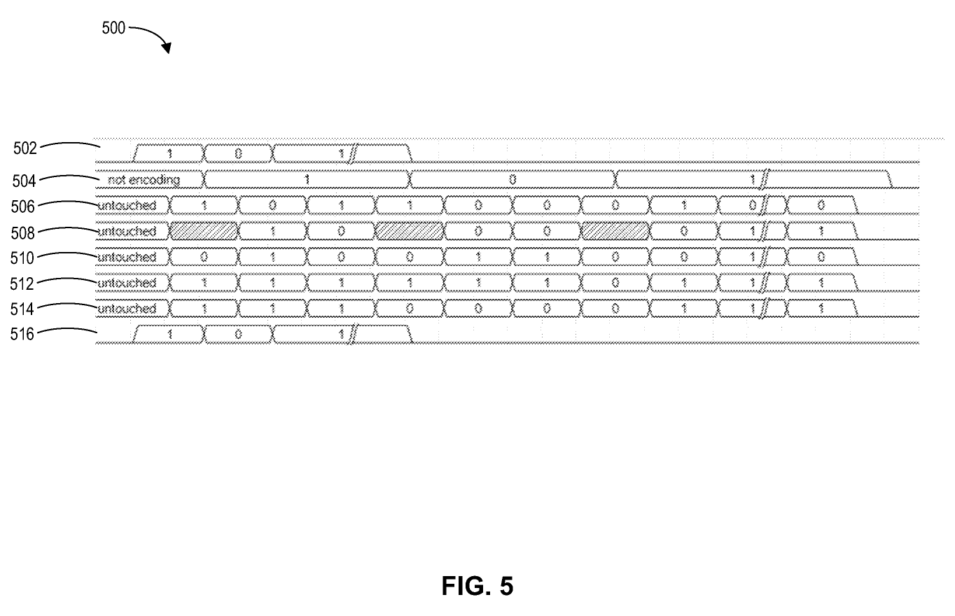

Reference is now additionally made to FIG. 5, which shows a diagram 500 of example decoding of a backscattered signal using method 300. Diagram 500 shows an example target payload data 502, an example repetition-encoded target payload data 504, the symbols of an example original Wi-Fi frame 506 that includes a pre-defined data payload for backscattering, the symbols of the resulting backscattered frame 508 that is received at a receiving device, and data 510 after receiver processing (e.g., differential decoding and descrambling). Further, diagram 500 shows example data 512 after the processing device applies a reverse codeword translation on each symbol of the modified data payload. As illustrated in diagram 500, example data 512 may not match the example target payload data 502 because of the previous processing applied by the receiving device. Diagram 500 further shows example data 514 after the processing device applies further processing (e.g., scrambling and differential encoding) to reverse the effects of the previous processing applied by the receiving device. Diagram 500 further shows example data 516 after removing repetition encoding, As shown in FIG. 5, this can enable recovery of the target payload data 502.

In some embodiments, removing the at least one repeated data bit comprises looping, at the processing device, through the output payload to remove a pre-determined quantity of data repetitions from the output payload. For example, the repetition removal block may be configured to remove the bit repetitions by using prior knowledge of how many bit repetitions will be used at the backscattering device when the payload data is encoded in the backscattered frame. The repetition block may be configured to loop through the sequence and periodically remove an amount of repetitions corresponding to the prior known number of repetitions added.

In some embodiments, the removing the at least one repeated data bit comprises applying, at the processing device, one or more convolution kernels to the output payload to produce one or more correlation outputs, each convolution kernel having a different kernel size, and determining, at the processing device, a repetition factor based on a peak frequency associated with each of the one or more filtered payloads. For example, where the number of repetitions is not pre-determined or previously known and must be determined when the signal is processed at the processing device, the number of repetitions can be determined using a set of convolution kernels of varying sizes. As an example, convolution kernels of sizes ranging from 3 to n can be used, where n is the largest expected repetition number. A convolution may be performed on the repetition-coded data for each kernel size to produce a correlation output. The correlation output for the kernel size that matches the number of bit repetitions will produce peaks at a frequency matching the kernel size, therefore allowing the determination of the repetition quantity.

In some embodiments, the processing device may be configured to sample the output payload at a frequency equal to the repetition quantity to remove the repetitions. For example, if 3 repetitions are used, the processing device may sample the repetition coded data at every 3 bits to extract a non-repetition coded version of the sequence.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A method for backscatter communication comprising:
transmitting, by a transmitter, a signal comprising a template frame, the template frame comprising a pre-defined template payload;
receiving, at a backscattering device from the transmitter, the signal comprising the template frame;
generating, at the backscattering device, a repetition coded message based on a target payload by repeating each bit of the target payload at least three times sequentially;
encoding, at the backscattering device, the repetition coded message over the template frame based on a synchronization with the pre-defined template payload to generate a modified data payload;
transmitting, at the backscattering device, a backscattered signal comprising a backscattered frame, the backscattered frame comprising the modified data payload;
receiving, at a receiving device, the backscattered signal and providing the received signal to a processing device; and
decoding, at the processing device, the signal from the receiving device to recover the target payload.

2. The method of claim 1, wherein encoding the repetition coded message over the template frame comprises performing a codeword translation on each symbol of the pre-defined template payload based on a corresponding bit of the repetition coded message.

3. The method of claim 2, wherein decoding the signal from the receiving device comprises:
applying, at the processing device, a reverse codeword translation corresponding to the codeword translation performed at the backscattering device and based on the pre-defined template payload to recover the modified data payload.

4. The method of claim 3, wherein decoding the signal from the receiving device further comprises reversing, at the processing device, at least one processing operation applied to the backscattered signal by the receiving device.

5. The method of claim 4, wherein reversing the at least one processing operation applied to the backscattered signal by the receiving device comprises:
scrambling, at the processing device, a frame of the signal from the receiving device using an all-zero initial seed, thereby generating an intermediate data payload; and
differentially encoding, at the processing device, the intermediate data payload, thereby generating an output payload.

6. The method of claim 5, wherein decoding the signal from the receiving device further comprises removing, at the processing device, at least one repeated data bit from the output payload to recover the target payload.

7. The method of claim 6, wherein removing the at least one repeated data bit comprises looping, at the processing device, through the output payload to remove a pre-determined quantity of data repetitions from the output payload.

8. The method of claim 6, wherein removing the at least one repeated data bit comprises:
applying, at the processing device, one or more convolution kernels to the output payload to produce one or more correlation outputs, each convolution kernel having a different kernel size;
determining, at the processing device, a repetition factor based on a peak frequency associated with each of the one or more correlation outputs.

9. A system for backscatter communication, the system comprising:
a transmitter configured to:
transmit a signal comprising a template frame, the template frame comprising a pre-defined template payload;
a backscattering device configured to:
receive, from the transmitter, the signal comprising the template frame;
generate a repetition coded message based on a target payload by repeating each bit of the target payload at least three times sequentially;
encode the repetition coded message over the template frame based on a synchronization with the pre-defined template payload to generate a modified data payload; and
transmit a backscattered signal comprising a backscattered frame, the backscattered frame comprising the modified data payload;
a receiving device configured to:
receive the backscattered signal and provide the received signal to a processing device; and
a processing device configured to:
decode the signal from the receiving device to recover the target payload.

10. The system of claim 9, wherein the backscattering device is further configured to encode the repetition coded message over the template frame by performing a codeword translation on each symbol of the pre-defined template payload based on a corresponding bit of the repetition coded message.

11. The system of claim 10, wherein the processing device is further configured to decode the signal from the receiving device by:
applying a reverse codeword translation corresponding to the codeword translation performed at the backscattering device and based on the pre-defined template payload to recover the modified data payload.

12. The method of claim 11, wherein the processing device is further configured to decode the signal from the receiving device by reversing, at the processing device, at least one processing operation applied to the backscattered signal by the receiving device.

13. The system of claim 11, wherein the processing device is further configured to reverse the at least one processing operation applied to the backscattered signal by the receiving device by:
scrambling a frame of the signal from the receiving device using an all-zero initial seed, thereby generating an intermediate data payload; and
differentially encoding the intermediate data payload, thereby generating an output payload.

14. The system of claim 13, wherein the processing device is further configured to decode the signal from the receiving device by removing at least one repeated data bit from the output payload.

15. The system of claim 14, wherein the processing device is configured to remove the at least one repeated data bit from the output payload by looping through the output payload to remove a pre-determined quantity of data repetitions from the output payload.

16. The system of claim 14, wherein the processing device is configured to remove the at least one repeated data bit from the output payload by:
applying one or more convolution kernels to the output payload to produce one or more correlation outputs, each convolution kernel having a different kernel size; and
determining a repetition factor based on a peak frequency associated with each of the one or more correlation outputs.

17. A device for backscatter communication, the device being configured to:
receive a signal comprising a template frame, wherein the template frame comprises a pre-defined template payload;
generate a repetition coded message based on a target payload by repeating each bit of the target payload at least three times sequentially;
encode the repetition coded message over the template frame based on a synchronization with the pre-defined template payload to generate a modified data payload; and
transmit a backscattered signal comprising a backscattered frame, the backscattered frame comprising the modified data payload, and the modified data payload being decodable to recover the target payload after the backscattered signal is received.

18. The device of claim 17, wherein the device is further configured to encode the repetition coded message over the template frame by performing a codeword translation on each symbol of the pre-defined template payload based on a corresponding bit of the repetition coded message.
